(19) United States
(12) Patent Application Publication
(10) Pub. No.: US 2003/0139944 A1
(43) Pub. Date: Jul. 24, 2003

(54) System and method for the processing of patient data

(76) Inventors: Ingwer Carlsen, Hamburg (DE); Cristian Lorenz, Hamburg (DE); Steffen Renisch, Hamburg (DE); Thorsten Schlathoelter, Ladbergen (DE); Frans Wessel Zonneveld, Middelbeers (NL)

Correspondence Address: PHILIPS ELECTRONICS NORTH AMERICAN CORP, 580 WHITE PLAINS RD, TARRYTOWN, NY, 10591, US

(21) Appl. No.: 10/315,813

(22) Filed: Dec. 10, 2002

(30) Foreign Application Priority Data
Dec. 14, 2001 (DE) 10161381.4

(51) Int. Cl. G06F 17/60; G06K 9/00; G06K 9/54; G06K 9/60

(52) U.S. Cl. 705/2; 382/128; 382/305

(57) ABSTRACT

The invention relates to a patient data processing system as well as to a corresponding method for the protocol-driven processing of patient data. In order to transfer standard and routine activities to a computer and to automate the execution thereof as much as possible, the invention proposes a patient data processing system which includes:

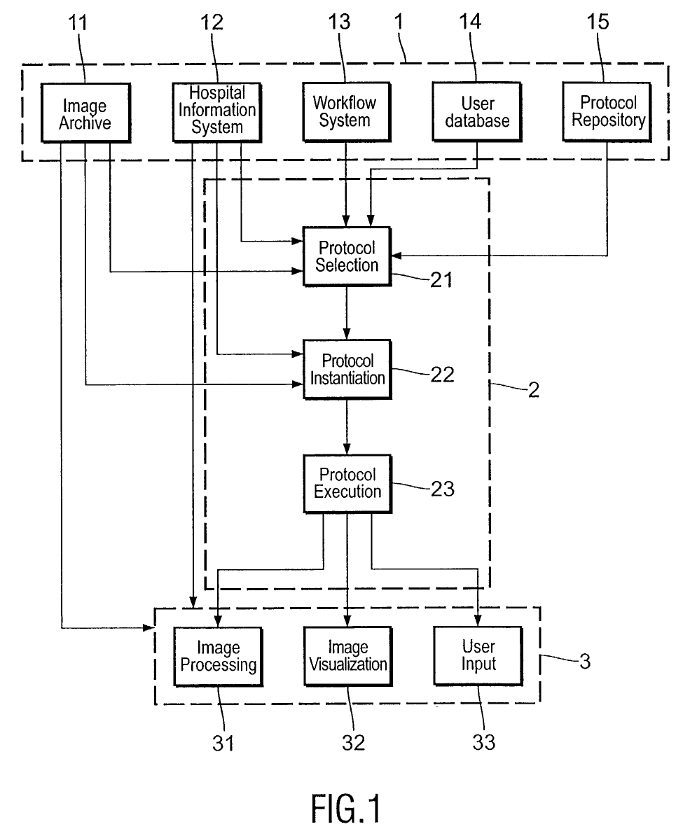

a) a patient data storage unit for storing patient data,

b) a protocol storage unit for storing standard protocols for the automatic processing of patient data,

c) a protocol selection unit for selecting, on the basis of the patient data, a standard protocol from the protocol storage unit,

d) a protocol instantiation unit for converting, on the basis of the patient data, the selected standard protocol into a patient-related protocol,

e) a protocol execution unit for executing the patient-related protocol, and

f) a data processing unit for carrying out the steps of the protocol and for outputting the processing result.

The invention relates to a patent data processing system for the protocol-driven processing of patient data, to a protocol execution device, to a patient data processing method as well as to a computer program for carrying out the method.

Conventional workflow systems for supporting clinical routines are known and available, for example, from the firm Algotec under the name of “Medilink” or “Mediflow” (domain http://www.algotec.com/products/). These systems are used to ensure that the information flow in a clinic, notably patient data such as personal data, analysis reports, image data etc., is directed to the correct locations in the clinic and becomes available in electronic form at all necessary apparatus. Moreover, status messages can be applied from individual apparatus to other apparatus, thus enabling automatic electronic work planning. The activities within individual systems, however, are not driven by the workflow systems.

It is an object of the present invention to provide a patient data processing system and a corresponding method which enable automation of the activities in the apparatuses used for analysis. This object is achieved in accordance with the invention by means of a patient data processing system as disclosed in claim 1, which system includes:

a) a patient data storage unit for storing patient data,

b) a protocol storage unit for storing standard protocols for the automatic processing of patient data,

c) a protocol selection unit for selecting a standard protocol from the protocol storage unit on the basis of the patient data,

d) a protocol instantiation unit for converting the selected standard protocol into a patient-related protocol on the basis of the patient data,

e) a protocol execution unit for executing the patient-related protocol, and

f) a data processing unit for carrying out the steps of the protocol and for outputting the processing result.

Claim 7 discloses a protocol execution device which forms an essential part of the patient data processing system in accordance with the invention. A method corresponding to the system disclosed in claim 1 is disclosed in claim 8. Moreover, the invention also relates to a computer program with computer program means for carrying out the steps of the method in accordance with the invention when it is run on a computer as disclosed in claim 9.

In accordance with the invention the activities in the apparatus used for the examination are controlled in conformity with a protocol. Thus, unlike in the known workflow systems, not only the final result of an examination, for example, the examination report or images formed, is electronically managed and distributed, but also the formation of the final result is automated. To this end, suitable units are proposed as part of the patient data processing system, said units being capable of selecting a suitable protocol which is then personalized, interpreted and executed on the basis of the patient data of the relevant patient to be examined. A further step is thus realized in the system automation which goes far beyond the capabilities of the workflow systems known thus far. Whereas these known systems comprise merely a patient data storage unit, for example, a clinical IT infrastructure, and data processing units, for example, medical workstations, in accordance with the invention there are additionally provided a protocol storage or repository unit, a protocol selection unit, a protocol instantiation unit and a protocol execution unit for carrying out the desired protocol selection and execution.

Advantageous further embodiments are disclosed in the dependent claims. For example, it is arranged that the patient data storage unit includes an image storage unit for storing patient-related medical image data and a clinical information system for storing patient-related information. Moreover, the data processing unit may also include an image processing unit, an image display unit and a user interface.

In accordance with the invention the protocol to be executed should be automatically selected from the plurality of standard protocols. To this end, the available patient data is evaluated, notably the patient history such as, for example, age, sex, previous ailments, suspected ailment and/or medical image data of the patient. The protocol selection is subject to a number of conditions and can be executed, for example, by means of an appropriate expert system.

Preferably, the standard protocols include protocol steps for the automatic image processing, image visualization, image acquisition and/or forming the diagnosis. Thus, as many steps as possible should be automated.

A further embodiment is provided with a workflow unit for controlling the patient data to be processed or the patients to be dealt with.

The invention will be described in detail hereinafter with reference to the sole Figure which shows a block diagram of a patient data processing system in accordance with the invention. The first step in the processing of patient data in accordance with the invention, which data is stored on the one hand in the form of medical image data of patients in an image memory or archive 11 and on the other hand in the form of other patient-related information in a clinical or hospital information system 12, consists in that a workflow unit or system 13 requests the processing of a new case, for example, the formation of a diagnosis for a new patient (case request). This request is sent to one or more medical workstations which include a protocol device 2 and a data processing unit 3 in accordance with the invention. When the case is accepted by a workstation or the person using this workstation, for example, a medical-technical assistant or a radiologist, a protocol selection unit 21 first selects a standard protocol automatically from a series of standard protocols stored in a protocol storage unit or repository 15. The appropriate standard protocol is then selected on the basis of the available patient data, for example notably the patient history (age, sex, suspected ailment, etc.), the type of acquired images etc. The protocol selection is performed notably on the basis of a number of conditions and is preferably carried out by means of an appropriate expert system.

After selection, the protocol must be instantiated. This means that in the locations in the standard protocol which refer to patient data, for example, to image data, personal data, diagnoses, etc. there must be entered the actually present patient data which refers to the patient being dealt with at the moment. This operation is performed in the protocol instantiation unit 22 which accesses the patient data stored in the units 11 and 12. Thus, the abstract functionality for the execution of the protocol must be mapped on the real functionality of the medical workstation executing the operations. This process yields a protocol which can be executed on the workstation and is formulated, for example, in a contemporary computer script language.

Subsequently, this protocol is executed in a protocol execution unit 23, meaning that the appropriate processing, visualization or interaction functionalities are carried out step by step in the data processing unit 3 which comprises an image processing unit 31, an image visualization unit 32 and a user interface or input 33 for this purpose.

The automatic patient data processing method in accordance with the invention is preferably used for the complete diagnostic process and the drafting of the diagnosis report, for example, in a department of radiology in a hospital. This necessitates the presence of an adequate medical IT infrastructure, notably medical workstations, a suitable network, a radiology information system and an electronic image data archive. The method can be used for any imaging modality such as computed tomography, magnetic resonance tomography, ultrasound, X-ray as well as other clinical data acquisition methods such as electrocardiography.

The method in accordance with the invention enables a significant enhancement of the efficiency of image-aided medical diagnosis and reporting in that standard processes are automated. This gives rise to an increased cost efficiency and to faster drafting of reports. Quality management is also enhanced because the automatic data processing system makes it possible to use standard methods and to introduce test steps, for example, for checking the completeness of reports or data. Additionally, the efficiency of data storage and data processing is increased, because preferably exclusively electronic documents and methods are employed.

A concrete example concerns a case where an aneurysm is suspected in the circle of Willis. For the diagnosis it is desired to perform a cranial CTA scan of the base of the skull. The selected protocol then concerns the post-processing of this scan.

During a first step of the protocol a patient-related co-ordinate system is defined first. To this end, three orthogonal views of the image data acquired are formed by means of an image visualization system, for example, by means of an orthoviewer. The user is requested to define the central sagittal plane through three or more points, the left-right axis with two dedicated markers in the inner ear, and the front-rear axis by two dedicated markers in the base of the skull.

A sub-volume to be reconstructed is automatically defined in a second step. The defined co-ordinate system is then used to calculate the co-ordinates of the corner points of a square volume of interest which contains the circle of Willis. During a subsequent third step the square volume is visualized together with the image data in the orthoviewer. The user then has the possibility of retaining the selected square or to carry out manual adjustments.

During an (optional) fourth step bone structures within the selected sub-volume can be removed semi-automatically. To this end, the user is asked whether automatic marking should be performed for improved visualization of the image voxels containing bone structures; the relevant voxels can then be excluded from subsequent visualizations. The result of this automatic operation is either acknowledged by the user, or manually corrected or rejected. Subsequently, in a fifth step maximum intensity projections (MIP) are formed which are oriented along the patient co-ordinate system. To this end, preferably three projections of the selected sub-volume are formed along the three mutually perpendicular spatial directions.

During a sixth step a set of maximum intensity projections of the sub-volume in the form of a bucket wheel is formed. The bucket wheel axis is then oriented along the left-right axis of the patient. Prior to the formation of the projections the user may also be asked whether the parameters used for generating the set of projections, for example, the angular increment and the number of projections, has to be accepted or modified. Optionally, in a seventh step a suitable print layout can be selected so that copies on film can be made of the projections formed.

During an eighth step a suitable specimen for a report can be selected, for example, the specimen “CTA circle of Willis, suspected aneurysm”. The demographic patient data is automatically inserted therein and the set of projections formed is attached to the report. Finally, the diagnosis and the report are made on the basis of the projections formed.

As explained above, in the present case an allocation of tasks takes place for standard cases. For example, the steps 1 to 8 described above are carried out by a technical assistant and the step 9 by a radiologist who, of course, may also be involved in the steps 1 to 8 in difficult cases. Finally, the method can be carried out once more if the result is not satisfactory.

The selection and the execution of the protocol are dependent to a high degree on the relevant patient history or on any special situations involved in the current case. For example, when a two-year old CTA scan of the patient is available, the protocol described above can be modified in such a manner that an automatic registration step is inserted after the step 6. During this registration step the new CTA scan is automatically registered with the previous CTA scan. Both scans as well as an overlay representation of the two scans can then be visualized in the orthoviewer. Upon request it is also possible to form additional projections for the old data set.

The clinical methods carried out are dependent to a high degree on the context of the examination. Different protocols are used for different patient histories and scan methods. Moreover, the protocols are adapted, prior to the execution, to the special aspects of the patient or also to special aspects of the hospital or the staff. Hereinafter various aspects will be described on the basis of individual examples which may be of relevance for the selection and concretization of a protocol:

a) the special case: case history, for example, suspected stroke;

b) the scan method: the visualized anatomical region, the use of contrast media etc., for example, CT scan with contrast medium;

c) the patient: sex, age, weight, etc., for example, patient A;

d) the hospital: local circumstances, schools, for example, general hospital B;

e) the user finction: work sharing aspects, for example, assistant, radiologist;

f) the personality of the user: personal aspects or preferences, for example, radiologist C;

g) the workstation: supported functionalities, limitations, for example, workstation D.

At the beginning of an examination a protocol is selected from the protocol repository in conformity with the above context information. The protocol defines at which points a given status is reached which must be communicated to other units of the IT infrastructure, for example, the information that the data preparation has been carried out, that the report has been signed etc. This type of communication allows the protocol to influence the work lists of the staff involved in order to reduce delays between successive activities.

The protocol itself specifies the activity to be carried out as well as the associated parameters and necessary user interactions. An important aspect of the protocol-driven execution of the method is the allocation of work, the associated responsibilities and rights among the various persons involved. For example, an assistant is authorized to select a protocol for a report and to enter special patient data, but is not authorized to enter the diagnosis or to sign the report. Authorizations of this kind may also be taken up in the standard protocols.

The following list provides a survey of general activities which can potentially be carried out automatically in a protocol-driven manner:

image post-processing steps such as, for example, noise reduction or resampling;

image segmentation, for example, removal of bones or determination of the axes of rotation of tubular structures;

definition of patient-related positions, orientations or co-ordinate systems such as, for example, the central sagittal plane;

definition of the region of interest, for example, orientation, position and thickness of sub-volumes;

selection of visualization methods, for example, MPR, MIP, mIP, CVP, DVR or virtual endoscopy, and the associated sets of parameters, for example, level and window;

definition and formation of dedicated sets of renderings, for example, for a bucket-wheel reconstruction;

definition of a visualization protocol;

film layout and print;

selection of an electronic specimen message and insertion of simple entries, for example, patient and scan information or standard observations;

archiving of data;

sending message.

1. A patient data processing system for the protocol-driven processing of patient data, which system includes:
a) a patient data storage unit (11, 12) for storing patient data,
b) a protocol storage unit (15) for storing standard protocols for the automatic processing of patient data,
c) a protocol selection unit (21) for selecting a standard protocol from the protocol storage unit (15) on the basis of the patient data,
d) a protocol instantiation unit (22) for converting the selected standard protocol into a patient-related protocol on the basis of the patient data,
e) a protocol execution unit (23) for executing the patient-related protocol, and
f) a data processing unit (3) for carrying out the steps of the protocol and for outputting the processing result.

2. A patient data processing system as claimed in claim 1, characterized in that the patient data storage unit (11, 12) includes an image storage unit (11) for storing patient-related medical image data and a clinical information system (12) for storing patient-related information.

3. A patient data processing system as claimed in claim 1, characterized in that the data processing unit (3) includes an image processing unit (31), an image visualization unit (32) and a user interface (33).

4. A patient data processing system as claimed in claim 1, characterized in that the protocol selection unit (21) is arranged to select a standard protocol on the basis of the patient history, stored in the form of patient data, and/or medical image data of the patient.

5. A patient data processing system as claimed in claim 1, characterized in that the standard protocols include protocol steps for automatic image processing, image visualization, image acquisition and/or drafting of an analysis report.

6. A patient data processing system as claimed in claim 1, characterized in that there is provided a work flow unit (13) for controlling the patient data to be processed or the patient to be dealt with.

7. A protocol device for the protocol-driven processing of patient data, which device includes:
a) a protocol selection unit (21) for selecting a standard protocol from a plurality of standard protocols, stored in a protocol storage unit (15), for the automatic processing of patient data on the basis of patient data stored in a patient data storage unit (11, 12),
b) a protocol instantiation unit (22) for converting the selected standard protocol into a patient-related protocol on the basis of the patient data,
c) a protocol execution unit (23) for executing the patient-related protocol, and
d) a data processing unit (3) for carrying out the steps of the protocol and for outputting the processing result.

8. A patient data processing method for the protocol-driven processing of patient data, which method includes the steps of:
a) protocol selection for selecting a standard protocol from a plurality of standard protocols, stored in a protocol storage unit (15), for the automatic processing of patient data on the basis of patient data stored in a patient data storage unit (11, 12),
b) protocol instantiation for converting the selected standard protocol into a patient-related protocol on the basis of the patient data,
c) protocol execution for executing the patient-related protocol, and
d) data processing for carrying out the steps of the protocol and outputting the processing result.

9. A computer program which includes computer program means for carrying out the steps of the method claimed in claim 8 when the method is executed on a computer.
